(19) United States
(12) Patent Application Publication
(10) Pub. No.: US 2026/0320155 A1
(43) Pub. Date: Oct. 15, 2026

(54) TIME-SERIES DATA PROCESSING

(71) Applicant: MASHANG CONSUMER FINANCE CO., LTD., Chongqing (CN)

(72) Inventors: Wanjie TAO, Chongqing (CN); Zhikuo CHEN, Chongqing (CN); Haoxin SHEN, Chongqing (CN); Yanyan ZHENG, Chongqing (CN); Quan LU, Chongqing (CN)

(73) Assignee: MASHANG CONSUMER FINANCE CO., LTD., Chongqing (CN)

(21) Appl. No.: 19/438,174

(22) Filed: Dec. 31, 2025

(30) Foreign Application Priority Data
Apr. 9, 2025 (CN) 202510443103.3

(51) Int. Cl. G06F 18/211; G06F 18/22; G06F 18/25; G06F 123/02; G06N 3/042

(52) U.S. Cl. CPC G06F 18/211; G06F 18/22; G06F 18/253; G06N 3/042; G06F 2123/02

(57) ABSTRACT

A time-series data processing method includes: constructing a time-series curve diagram based on first time-series data and second time-series data; performing feature extraction on the time-series curve diagram to obtain a spatial relationship feature, performing association relationship recognition on the time-series curve diagram by using a neural network model to obtain a text, and performing feature extraction on the text to obtain an association relationship feature; merging the spatial relationship feature with the association relationship feature to obtain a merged feature, and performing feature retrieval in a time-series knowledge base based on the merged feature to obtain a candidate feature; and determining a similarity between the merged feature and the candidate feature, and determining a predicted label for the first time-series data based on the similarity and a time-series change label for the candidate feature.

### CROSS-REFERENCE TO RELATED APPLICATION

The present application claims priority to and the benefit of Chinese Patent Application No. 202510443103.3, filed on Apr. 9, 2025, the disclosure of which is incorporated herein by reference in its entirety.

### TECHNICAL FIELD

The present disclosure relates to data processing technologies, and more particularly, to time-series data processing.

### BACKGROUND

With the development and progress of the Internet and information technology, an increasing number of services are carried out through the Internet. Consequently, there is an increasing amount of data managed and maintained through the Internet, and there is an increasing amount of data to be analyzed using the Internet. On the other hand, time-series data (for example, that of a natural environment) including a series of data arranged in sequence of time, where each data point is associated with a specific point in time, may be generally used to analyze and predict future trends, patterns, or behaviors. How to improve the accuracy of analyzing and predicting the future trends, patterns, or behaviors based on the time-series data is increasingly concerned by data analysts and service providers offering services based on the time-series data.

### SUMMARY

In a first aspect, some embodiments of the present disclosure provide a time-series data processing method including: constructing a time-series curve diagram based on first time-series data and second time-series data; performing feature extraction on the time-series curve diagram to obtain a spatial relationship feature, performing association relationship recognition on the time-series curve diagram by using a neural network model to obtain a text, and performing feature extraction on the text to obtain an association relationship feature; merging the spatial relationship feature with the association relationship feature to obtain a merged feature, and performing feature retrieval in a time-series knowledge base based on the merged feature to obtain one or more candidate features; and determining one or more similarities respectively for the one or more candidate features, where each of the one or more similarities is a similarity between the merged feature and one of the one or more candidate features, and determining a predicted label for the first time-series data based on the one or more similarities and one or more time-series change labels respectively for the one or more candidate features.

In a second aspect, some embodiments of the present disclosure provide a time-series data processing apparatus including: a constructing module, configured to construct a time-series curve diagram based on first time-series data and second time-series data; a feature extraction module, configured to perform feature extraction on the time-series curve diagram to obtain a spatial relationship feature, perform association relationship recognition on the time-series curve diagram by using a neural network model to obtain a text, and perform feature extraction on the text to obtain an association relationship feature; a feature retrieval module, configured to merge the spatial relationship feature with the association relationship feature to obtain a merged feature, and performing feature retrieval in a time-series knowledge base based on the merged feature to obtain one or more candidate features; and a predicted label determining module, configured to determine one or more similarities respectively for the one or more candidate features, wherein each of the one or more similarities is a similarity between the merged feature and one of the one or more candidate features, and determining a predicted label for the first time-series data based on the one or more similarities and one or more time-series change labels respectively for the one or more candidate features.

In a third aspect, some embodiments of the present disclosure provide a time-series data processing device including: a processor; and a memory storing instructions executable by the processor to perform the time-series data processing method of the first aspect.

In a fourth aspect, some embodiments of the present disclosure provide a non-transitory computer-readable storage medium storing instructions executable by a processor to perform the time-series data processing method of the first aspect.

In a fifth aspect, some embodiments of the present disclosure provide a computer program product including a computer program executable by a processor to perform the time-series data processing method of the first aspect.

### BRIEF DESCRIPTION OF THE DRAWINGS

FIG. 1 schematically shows an environment where a time-series data processing method according to some embodiments of the present disclosure can be implemented.

FIG. 2 is a schematic flowchart of a time-series data processing method according to some embodiments of the present disclosure.

FIG. 3A schematically shows a layered arrangement of respective time-series curves according to some embodiments of the present disclosure.

FIG. 3B schematically shows a time-series curve diagram generated based on the layered arrangement as shown in FIG. 3A according to some embodiments of the present disclosure.

FIG. 4 schematically shows a process of feature extraction according to some embodiments of the present disclosure.

FIG. 5 schematically shows a process of time-series data processing applicable to a time-series trend prediction scenario according to some embodiments of the present disclosure.

FIG. 6 is a schematic flowchart of a time-series data processing method applicable to a time-series trend prediction scenario according to some embodiments of the present disclosure.

FIG. 7 is a schematic block diagram of a time-series data processing apparatus according to some embodiments of the present disclosure.

FIG. 8 is a schematic block diagram of a time-series data processing device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

In practice, there are various time-series trend prediction methods, but each of the time-series trend prediction methods has its own limitations. For example, the linear model is not good when dealing with the nonlinear relationship and long-term prediction. The nonlinear model may capture more complex data relationships, but it faces challenges in parameter selection, prediction accuracy, and training efficiency. The method based on the large language model requires customized processing for numerical tokenization and textual representation, and the numerical tokenization affects the performance of the model based on the large language model. Moreover, enabling the large language model to learn a wide range of scenario knowledge and to predict the time-series trend based on the scenario knowledge also encounters issues related to the accuracy and timeliness of the knowledge.

In order to improve the efficiency and effectiveness of time-series trend prediction, an embodiment of the present disclosure provides a time-series data processing method. A time-series curve diagram is constructed according to first time-series data and second time-series data. A spatial relationship feature in a spatial dimension and an association relationship feature in an association dimension of the time-series curve diagram are respectively generated from the time-series curve diagram. The spatial relationship feature and the association relationship feature are merged to obtain a merged feature. Feature retrieval is performed in a time-series knowledge base based on the merged features to obtain a candidate feature. Similarity between the merged feature and the candidate feature is determined, and a predicted label of the first time-series data is determined based on the similarity and a time-series change label for the candidate feature. Therefore, model training and model optimization are not required. In the process of determining the predicted label of the first time-series data, feature extraction in the spatial dimension and feature extraction in the association dimension are realized from the time-series curve diagram. Further, the degree of characterization of the time-series data by the merged features characterized by the time-series data is obtained by merging the relationship features of the two dimensions. Further, by merging the spatial and association relationship features in two dimensions, the merged feature for the time-series data representation achieves a higher level of representational capacity, thereby improving the accuracy of determining the predictive label from the merged feature. The time-series knowledge base is pre-configured, so that the predicted label may be determined by feature extraction and feature retrieval in the process of determining the predicted label of the time-series data, thereby improving the efficiency of determining the predicted label.

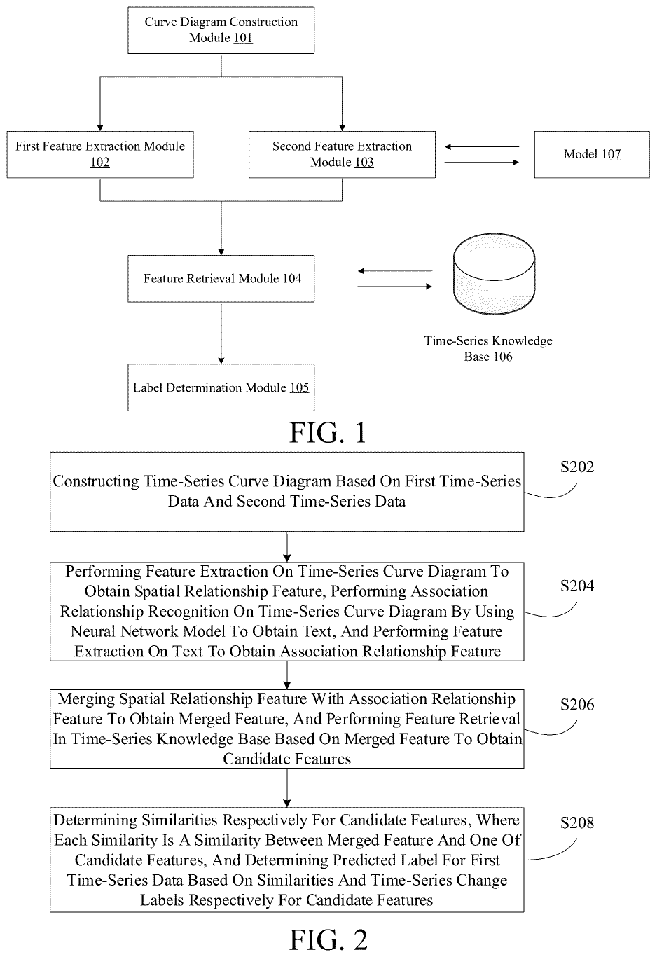

The time-series data processing method according to one or more embodiments of the present disclosure is applicable to an implementation environment of time-series trend prediction. As shown in FIG. 1, the implementation environment includes at least a curve diagram construction module 101, a first feature extraction module 102, a second feature extraction module 103, a feature retrieval module 104, a label determination module 105, a time-series knowledge base 106, and a model 107.

The curve diagram construction module 101 is configured to construct a time-series curve diagram based on first time-series data and second time-series data.

The first feature extraction module 102 is configured to perform feature extraction of a spatial dimension on the time-series curve diagram to obtain a spatial relationship feature.

The second feature extraction module 103 is configured to perform feature extraction of an association dimension on the time-series curve diagram by using the model 107 to obtain an association relationship feature.

The feature retrieval module 104 is configured to merge the spatial relationship feature with the association relationship feature to obtain a merged feature, and perform feature retrieval in the time-series knowledge base 106 based on the merged feature to obtain one or more candidate features.

The label determination module 105 is configured to determine similarities for the one or more candidate features, wherein each of the one or more similarities is a similarity between the merged feature and one of the one or more candidate features, and determine a predicted label of the first time-series data based on the similarities and time-series change labels for the one or more candidate features.

The time-series knowledge base 106 is configured to store a time-series data record consisting of the time-series relationship feature and the time-series change label.

The model 107 is configured to recognize associative relationships between time-series curves in the time-series curve diagram and output a text for describing the associative relationships between the time-series curves in the time-series curve diagram. The model 107 is a neural network model that may be a large-scale visual language model, such as Large Vision Language Model (LVLM).

In this implementation environment, in the process of time-series trend prediction, firstly, the time-series curve diagram is constructed by the curve diagram construction module 101 based on the first time-series data and the second time-series data. Then, on the one hand, the feature extraction is performed on the time-series curve diagram by the first feature extraction module 102 to obtain the spatial relationship feature, on the other hand, the feature extraction is performed on the time-series curve diagram is extracted by the second feature extraction module 103 by using the model 107 to obtain the association relationship feature, and then the spatial relationship feature and the association relationship feature are merged by the feature retrieval module 104 to obtain the merged feature, and the feature retrieval is performed in the time-series knowledge base 106 based on the merged feature to obtain the candidate feature. Finally, the predicted label of the first time-series data is determined by the label determination module 105 based on the time-series change labels for the candidate features and the similarities respectively between the merged feature and the candidate features. Therefore, the efficiency and simplicity of determining the predicted label of the first time-series data may be improved, and the accuracy of the determined predicted label may be improved.

FIG. 2 is a flowchart of a time-series data processing method according to an embodiment of the present disclosure. Referring to FIG. 2, the time-series data processing method according to an embodiment of the present disclosure includes Steps S202 to S208.

At Step S202, a time-series curve diagram is constructed based on first time-series data and second time-series data.

The first time-series data in an embodiment includes time-series data for time-series trend prediction. The second time-series data includes at least one time-series data related to the first time-series data. For example, the first time-series data represents temperature time-series data of a city c1, and the second time-series data may include: humidity time-series data of city c1, wind time-series data of city c1, air-quality-index time-series data of city c1, and/or temperature time-series data of a neighboring city c2 around city c1.

In an example, the time-series curve diagram is constructed based on the first time-series data and the second time-series data. The time-series curve diagram includes a curve diagram, including time-series curves respectively corresponding to the first and second time-series data, generated by arranging these time-series curves respectively corresponding to the first and second time-series data.

In order to ensure that the first time-series data and the second time-series data for constructing the time-series curve diagram are synchronized in time thereby ensuring the validity of the constructed time-series curve diagram, the first time-series data correspond to a same time period as that correspond to the second time-series data, that is, the time corresponding to the first time-series data and the time corresponding to the second time-series data are synchronized.

In the process of constructing the time-series curve diagram based on the first time-series data and the second time-series data, the time-series curves respectively corresponding to the first time-series data and the second time-series data may be first generated, and then the time-series curve diagram is generated from the time-series curves. In an alternative embodiment of the present disclosure, the constructing of the time-series curve diagram based on the first time-series data and the second time-series data may include: generating a first time-series curve based on the first time-series data, and generating a second time-series curve based on the second time-series data; and generating the time-series curve diagram based on the first time-series curve and the second time-series curve.

The first time-series curve is first generated based on the first time-series data, the second time-series curve is generated based on the second time-series data, and then the time-series curve diagram is generated based on the first time-series curve and the second time-series curve, so that feature extraction is performed on the time-series curve diagram from the spatial dimension and the association dimension, respectively.

In order to make the generated first time-series curve and the generated second time-series curve on the same value scale and avoid that the values of the first time-series data cannot be aligned with the second time-series data, the step of generating the first time-series curve based on the first time-series data and generating the second time-series curve based on the second time-series data may include: normalizing the first time-series data and the second time-series data, to obtain first normalized time-series data and second normalized time-series data, respectively; and generating the first time-series curve based on the first normalized time-series data and generating the second time-series curve based on the second normalized time-series data.

On this basis, in order to facilitate the extraction of the spatial relationship feature and the association feature from the time-series curve diagram, the generating of the time-series curve diagram from the first time-series curve and the second time-series curve may include: arranging the first time-series curve and the second time-series curve in different layers; and generating the time-series curve diagram from the layered arrangement. In an embodiment, in the arranging of the first time-series curve and the second time-series curve in different layers, the arrangement priority of the first time-series curve is higher than the arrangement priority of the second time-series curve, and under the condition that the second time-series curve includes a plurality of second time-series curves, the priority of each of the second time-series curves may be randomly determined.

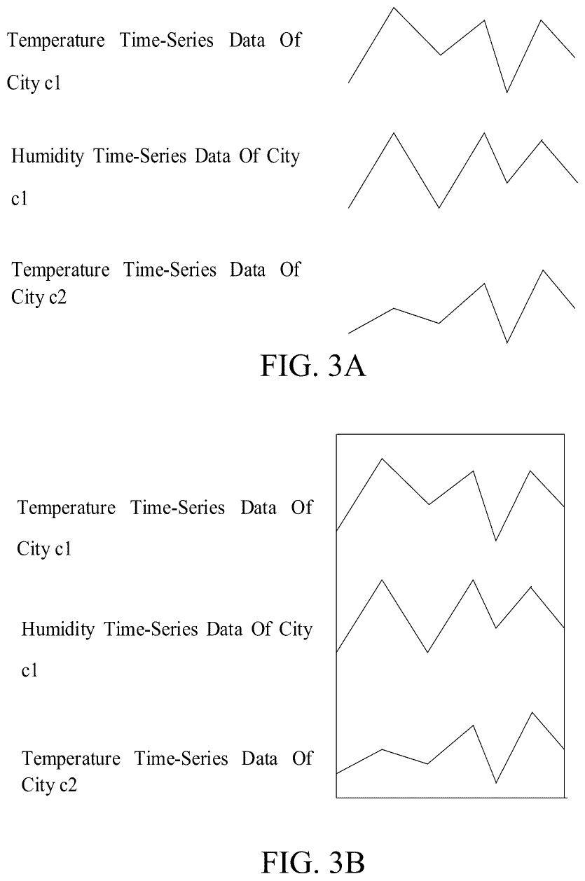

In an example, the first time-series data is the temperature time-series data of city c1, and the second time-series data includes the humidity time-series data of city c1 in the same time period as that of the temperature time-series data of city c1 and the temperature time-series data of city c2 in the same time period as that of the temperature time-series data of city c1. The max-normalization is performed on the temperature time-series data of city c1 to obtain normalized temperature time-series data of city c1, and the max-normalization is performed on the humidity time-series data of city c1 to obtain normalized humidity time-series data of city c1, and the max-normalization is performed on the temperature time-series data of city c2 is normalized to obtain normalized temperature time-series data of city c2. The normalized temperature time-series data corresponding to the temperature time-series curve of city c1, the normalized humidity time-series data corresponding to the humidity time-series curve of city c1, and the normalized temperature time-series data corresponding to the temperature time-series curve of city c2 are arranged in layers to obtain the layered arrangement as shown in FIG. 3A. Then, the time-series curve diagram shown in FIG. 3B is generated based on the layered arrangement.

At Step S204, feature extraction is performed on the time-series curve diagram to obtain a spatial relationship feature, a text is obtained by performing association relationship recognition on the time-series curve diagram, and feature extraction is performed on the text to obtain an association relationship feature.

In an implementation, after the time-series curve diagram is constructed based on the first time-series data and the second time-series data, the feature extraction is performed on the time-series curve diagram from the spatial dimension and the association dimension to obtain the spatial relationship feature from the spatial dimension and the association relationship feature from the association dimension, respectively, thereby characterizing the time-series curve diagram from a plurality of dimensions, that is, the first time-series data is characterized from the plurality of dimensions in combination with the second time-series data. The association dimension in this embodiment includes a dimension for characterizing the causal influence relationship between the first time-series data and the second time-series data.

In the step of performing the feature extraction on the time-series curve diagram from the spatial dimension and the association dimension to obtain the spatial relationship feature and the association relationship feature, respectively, on one hand, the feature extraction is performed on the time-series curve diagram to obtain the spatial relationship feature, thereby visually displaying the spatial relationship between the first time-series data and the second time-series data from the image modality of the time-series curve diagram; on the other hand, the text is obtained by recognizing the time-series curve diagram, and the feature extraction is performed on such a text to obtain the association relationship feature, whereby expressing the association relationship, that is, the causal influence relationship, between the first time-series data and the second time-series data from the text modality.

Feature extraction in the spatial dimension and feature extraction of the association relationship feature in the association dimension are described in detail below.

### (1) Performing the Feature Extraction on the Time-Series Curve Diagram to Obtain the Spatial Relationship Feature

In an embodiment, the performing of the feature extraction on the time-series curve diagram includes: performing the feature extraction on the time-series curve diagram from the spatial dimension. The feature extraction is performed on the time-series curve diagram from the spatial dimension to reflect the commonalities and differences among the different time-series curves in the time-series curve diagram. In an example, the performing of the feature extraction on the time-series curve diagram from the spatial dimension includes extraction of synchronized trend features and distinctive features among the different curves in the time-series curve diagram.

The spatial relationship feature includes a feature for representing relationships between the different time-series curves in the time-series curve diagram from the spatial dimension. Accordingly, the spatial relationship feature may include the common change trends and the distinctive relationships among the different curves in the time-series curve diagram. For example, the time-series curve diagram includes the temperature time-series curve of city c1, the humidity time-series curve of city c1, and the temperature time-series curve of city c2. The feature extraction is performed on the time-series curve diagram from the spatial dimension, to obtain the certain synchronized trend features and the distinctive features among the temperature of city c1, the humidity of city c1, and the temperature of city c2 as the spatial relationship feature.

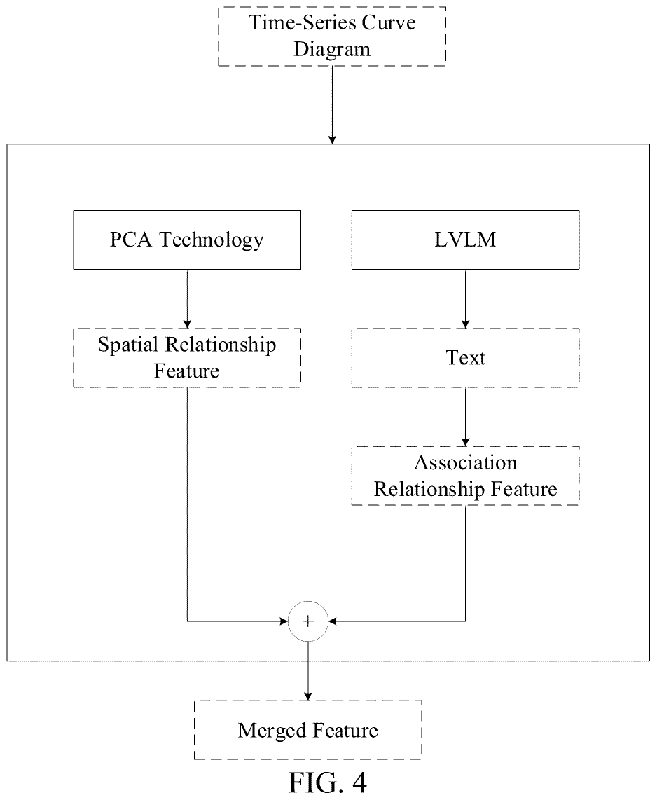

In an embodiment, the performing of the feature extraction on the time-series curve diagram to obtain the spatial relationship feature includes: performing the feature extraction on the time-series curve diagram by using a Principal Component Analysis (PCA) technology to obtain the spatial relationship feature. For example, as shown in FIG. 4, the PCA technology is used to extract one or more features from the time-series curve diagram to obtain the one or more spatial relationship feature.

The spatial relationship feature obtained by extracting the spatial feature of the time-series curve diagram by using the PCA technology may be a one-dimensional vector of 1×F1.

In an alternative embodiment, in order to improve the validity of the feature extraction and the accuracy of the obtained spatial relationship feature, the performing of the feature extraction on the time-series curve diagram to obtain the spatial relationship feature includes: performing image sampling on a first time-series curve and a second time-series curve in the time-series curve diagram to obtain first sample data and second sample data, respectively; merging the first sample data with the second sample data to obtain a merged data matrix, and computing a covariance matrix of the merged data matrix; and performing eigen decomposition on the covariance matrix to obtain the spatial relationship feature.

In an example, the first time-series data corresponding to the first time-series curve in the time-series curve diagram and the second time-series data corresponding to the second time-series curve in the time-series curve diagram may be merged to obtain a merged data matrix, then computation is performed on the merged data matrix to obtain the covariance matrix of the merged data matrix, and finally the eigen decomposition is performed on the covariance matrix to obtain the spatial relationship feature.

### (2) Performing Association Relationship Recognition on the Time-Series Curve Diagram by Using the Neural Network Model to Obtain the Text, and Performing Feature Extraction on the Text to Obtain an Association Relationship Feature

The association relationship in an embodiment includes a causal influence relationship among the time-series curves in the time-series curve diagram. The recognizing of the time-series curve diagram to obtain the text includes: recognizing the causal relationship among the time-series curves in the time-series curve diagram to obtain the text for describing the causal relationship among the time-series curves. Accordingly, the text includes the text for describing the causal relationship among the time-series curves. For example, the time-series curve diagram includes the temperature time-series curve of city c1, the humidity time-series curve of city c1, and the temperature time-series curve of city c2, and the time-series curve diagram is recognized to obtain the text for describing the time-series curve: “the change in the temperature of city c2 will result in the change in the humidity of city c1, and thus result in the change in the temperature of city c1”.

The performing of the feature extraction on the text includes vectorizing the text. The association relationship feature includes a feature for describing the causal influence relationship among the time-series curves in the time-series curve diagram by performing a feature conversion on the causal influence relationship among the time-series curves.

In an embodiment, the time-series curve diagram is recognized by the model to obtain the text. The model includes such as Large Vision Language Model (LVLM). For example, as shown in FIG. 4, the time-series curve diagram is recognized by LVLM to obtain the text. In an alternative embodiment, the time-series curve diagram and a prompt text are input into the model for recognition, to obtain the text. The prompt text may be used to instruct the model to recognize the first and second time-series curves included in the time-series curve diagram and to recognize a time-series change relationship between the first and second time-series curves. The time-series change relationship includes an influence relationship or the causal influence relationship between the first and second time-series curves. For example, the prompt text in an embodiment may be “Please recognize each time-series curve included in the time-series curve diagram, and recognize the causal influence relationship between any two ones of the time-series curves”.

During the recognition process, the model may first recognize the first and second time-series curves in the curve diagram according to the prompt text, recognize the time-series change relationship between the first time-series curve and the second time-series curve according to the prompt text, and then generate and output a text describing the time-series change relationship.

After the text is obtained by recognizing the time-series curve diagram by using the model, the feature extraction is performed on the text to obtain the association relationship feature. For example, the feature extraction is performed on the text to obtain the association relationship feature as shown in FIG. 4. The association relationship feature may represent the time-series change relationship.

In the performing of the feature extraction on the text to obtain the association relationship feature, the text may be vectorized to obtain a one-dimensional vector of 1×F2 as the association relationship feature.

Continue to illustrate the determining of the association relationship feature with an example where the first time-series data is the temperature time-series data of city c1, and the second time-series data includes the humidity time-series data of city c1 in the same time period as that of the temperature time-series data of city c1 and the temperature time-series data of city c2 in the same time period as that of the temperature time-series data of city c1. First, the LVLM is configured to recognize the association (i.e., causal influence) relationship, in the time-series curve diagram, between each of the humidity time-series data of city c1 and the temperature time-series data of city c2 and the temperature time-series data of city c1, to obtain the text, for describing the causal influence relationship, “as the temperature of city c2 decreases and the humidity of city c1 gradually decreases, the temperature of city c1 decreases”. This text is then vectorized to obtain the association relationship feature of the time-series curve diagram in the associative dimension.

It should be noted that, in an embodiment, by obtaining the spatial relationship feature of 1×F1 and the association relationship feature of 1×F2, each of the spatial relationship feature and the association relationship feature is set as a one-dimensional vector, thereby improving the efficiency of merging the spatial relationship feature with the association relationship feature.

At Step S206, the spatial relationship feature and the association relationship feature are merged to obtain a merged feature, and feature retrieval is performed in a time-series knowledge base based on the merged feature to obtain one or more candidate features.

In an implementation, after obtaining the spatial relationship feature in the spatial dimension and the association relationship feature in the association dimension, the spatial relationship feature and the association relationship feature are merged to obtain the merged feature. For example, the spatial relationship feature and the association relationship feature are merged to obtain the merged feature, as shown in FIG. 4.

In an embodiment, under the condition that the spatial relationship feature is the one-dimensional vector of 1×F1 and the association relationship feature is the one-dimensional vector 1×F2, the merged feature obtained by merging the spatial relationship feature with the association relationship feature may be a one-dimensional vector of 1×(F1+F2).

Once the merged feature is obtained by merging the spatial relationship feature with the association relationship feature, the feature retrieval is performed in the time-series knowledge base based on the merged feature to obtain the candidate feature.

In an embodiment, in order to improve the validity of the obtained candidate features, the feature retrieval may be performed in the time-series knowledge base based on the similarity between the merged feature and each of the time-series relationship features stored in the time-series knowledge base to obtain the candidate feature. In an alternative embodiment, the performing of the feature retrieval in the time-series knowledge base based on the merged feature to obtain the candidate feature may include: for each of the temporal relationship features,
computing a first similarity between the merged feature and the each of the time-series relationship features; and
in response to determining that the first similarity meets a preset condition, taking the each of the temporal relationship features as one of the one or more candidate features.

In an embodiment, the similarity between the merged feature and each time-series relationship feature stored in the time-series knowledge base may be computed according to a cosine formula. The performing of the feature retrieval in the time-series knowledge base based on the merged feature to obtain the candidate feature may include: computing a similarity between the merged feature and each time-series relationship feature stored in the time-series knowledge base; arranging the time-series relationship features stored in the time-series knowledge base in descending order of similarity, to obtain a time-series relationship feature list; and selecting one or more of the time-series relationship features before a preset position in the time-series relationship feature list as the one or more candidate features.

In an embodiment, the time-series knowledge base may be generated based on the first historical time-series data and second historical time-series data. In an example, the time-series knowledge base stores a time-series data record consisting of the time-series relationship features and the time-series change labels. The time-series relationship feature may be obtained by merging a historical spatial relationship feature and a historical association relationship feature of a historical time-series curve diagram constructed based on the first historical time-series data and the second historical time-series data, and the time-series change label for the time-series relationship feature may include the time-series trend of the first historical time-series data.

In an alternative embodiment, the history time interval corresponding to the first historical time-series data and the second historical time-series data is the same as that corresponding to the first and second time-series data, but precedes the time period corresponding to the first and second time-series data in time. The time-series data record in the time-series knowledge base is generated by the following steps:
constructing a history time-series curve diagram based on the first history time-series data and the second history time-series data, and determining a time-series change label based on the time-series trend of the first historical time-series data;
performing feature extraction on the historical time-series curve diagram to obtain a historical spatial relationship feature, recognizing the historical time-series curve diagram by using the model to obtain a historical text, and performing feature extraction on the historical text to obtain a historical association relationship feature; and
merging the historical spatial relationship feature and the historical association relationship feature to obtain a historical merged feature (or be referred to be the time-series relationship feature), and generating the time-series data record based on the historical merged feature and the time-series change label corresponding to the first and second history time-series data both in the same history time interval.

In an example, the time-series change label for the history merged feature includes a time-series change trend, a time-series change amount, and/or a time-series change pattern of the first history time-series data in a next time interval following the history time interval corresponding to the first history time-series data. For example, if the history time interval corresponding to the first history time-series data is T, the time-series change trend for the history merged feature is the time-series change trend within a (T+1)-th time interval.

In an embodiment, in order to construct a comprehensive time-series knowledge base, the historical time-series data may be segmented by using a sliding window method with a preset window size and a preset sliding step, to obtain a plurality of segments of first historical time-series data, a time-series data record for each of the plurality of segments of first historical time-series data is generated by using the above manner, and a time-series knowledge base is constructed based on the time-series data record for each of the plurality of segments of first historical time-series data.

For example, the historical temperature time-series data may be segmented by using a sliding window method with a preset window size of T and a preset sliding step of 1 to obtain a plurality of segments of first historical time-series data; a corresponding time-series change label for each of the segments of first historical temperature time-series data is determined based on a time-series change trend at a (T+1)-th time step for each segment of first historical temperature time-series data; under the condition that the time-series change trend is upward, it is determined that the time-series change label is one, otherwise, it is determined that the time-series change label is zero.

In order to further improve the comprehensive of the time-series knowledge base, the roles of the first historical time-series data and the second historical time-series data may be exchanged in the constructing of the time-series knowledge base, that is, a time-series data record for each segment of second historical time-series data based on the second historical time-series data.

For example, the first historical time-series data is historical temperature time-series data of city c1, the second historical time-series data is historical humidity time-series data of city c1 and the historical temperature time-series data of city c2. In alternative embodiment, the historical humidity time-series data of city c1 may be used as the first historical time-series data, and the historical temperature time-series data of city c1 and the historical temperature time-series data of city c2 may be used as the second historical time-series data for generating the time-series data record. Alternatively, the historical temperature time-series data of city c2 may be used as the first historical time-series data, and the historical temperature time-series data and the historical humidity time-series data of city c1 may be used as the second historical time-series data for generating the time-series data record. Alternatively, the historical temperature time-series data of city c2 may be used as the first historical time-series data, and the historical humidity time-series data of city c2 and the historical temperature time-series data of city c1 may be used as the second historical time-series data for generating the time-series data record.

It should be noted that the first historical time-series data and the second historical time-series data correspond to the same time period. That is, the time corresponding to the first historical time-series data synchronizes with the time corresponding to the second historical time-series data.

At Step S208, one or more similarities respectively for the one or more candidate features are determined, where each of the one or more similarities is a similarity between the merged feature and one of the one or more candidate features, and a predicted label for the first time-series data is determined based on the one or more similarities and one or more time-series change labels respectively for the one or more candidate features.

In an implementation, after the candidate features are obtained by performing the feature retrieval in the time-series knowledge base based on the merged feature, a predicted label for the first time-series data is determined based on the time-series change labels of the merged features and the candidate features. Alternatively, the time-series change label for the candidate feature may be read from the time-series data record stored in the time-series knowledge base, e.g., may be read from the time-series data record stored in the time-series knowledge base corresponding to the candidate feature. The time-series change label for the candidate feature may be a time-series change trend, a time-series change amount, and/or a time-series change pattern in a next time period or a next time interval following the time period or the time interval corresponding to the candidate feature.

The predicted label for the first time-series data includes a predicted label that represents a time-series change trend, a time-series change amount, and/or a time-series change pattern of the first time-series data.

In an embodiment, a predicted index of the merged feature may be first computed based on the similarities and time-series change labels respectively for the candidate features, and the label value of the predicted label is determined based on the predicted index. The predicted index of the merged feature may be an average value (or a weighted average value) of the weighted sum of the candidate features computed by taking the similarity between the merged feature and each candidate feature as a weight for the corresponding time-series change label. In an alternative embodiment, the determining of the predicted label for the first time-series data based on the similarities between the merged feature and respective ones of the candidate features and the time-series change labels for the candidate features may include: computing a weighted sum of the one or more time-series change labels by using the one or more similarities as respective weights for the one or more time-series change labels; and determining the label value of the predicted label based on the weighted sum.

In an embodiment, a weighted sum of the time-series change labels for the candidate features is computed by taking the similarity between the merged feature and each candidate feature as the weight for the corresponding time-series change label, then the weighted average value is computed based on the number of the candidate features and the weighted sum, and finally the value of the predicted label is determined based on the weighted average value.

For example, the predicted index, i.e., the weighted average value predScore, is obtained by the following formula:

predScore=1/NΣᵢ₌₁^{N}simScoreᵢ×labelᵢ,

where i is a positive integer, N represents the number of candidate features, simScoreᵢ represents the similarity between the merged feature and an i-th candidate feature, and labelᵢ represents the time-series change label for the i-th candidate feature.

After the weighted average value is obtained, the predicted label predLabel for the first time-series data is determined by the following formula:

$$predLabel = \{ \begin{matrix}0 & ifpredScore < 0.5 \\ 1 & ifpredScore \geq 0.5\end{matrix}$$

In sum, in the time-series data processing method according to some embodiments, the determining of the predicted label of the first time-series data may include: reading the second time-series data corresponding to the same time period as that of the first time-series data; constructing the time-series curve diagram based on the first time-series data and the second time-series data; performing the feature extraction on the time-series curve diagram by using the PCA technology to obtain the spatial relationship feature; performing association relationship recognition on the time-series curve diagram by using the model to obtain the text; and performing the feature extraction on the text to obtain the association relationship feature. Therefore, the spatial relationship feature in the spatial dimension and the association relationship feature in the association dimension are obtained, thereby improving the efficiency of the feature extraction on the time-series curve diagram by using the PCA technology and the model. The determining of the predicted label of the first time-series data may further include: merging the spatial relationship feature with the association relationship feature to obtain the merged feature; performing the feature retrieval in the time-series knowledge base based on the merged feature to obtain the candidate feature; determining the similarity between the merged feature and each candidate feature; and determining the predicted label of the first time-series data according to the similarity and the time-series change label for the candidate feature. Therefore, the candidate feature is determined by using a pre-configured time-series knowledge base, and then the predicted label for the first time-series data may be determined, thereby improving the efficiency of determining the predicted label for the first time-series data.

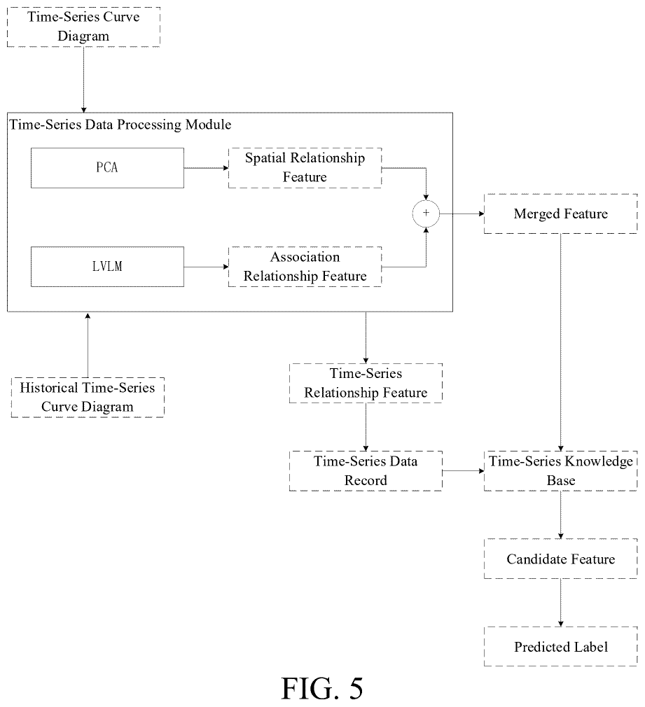

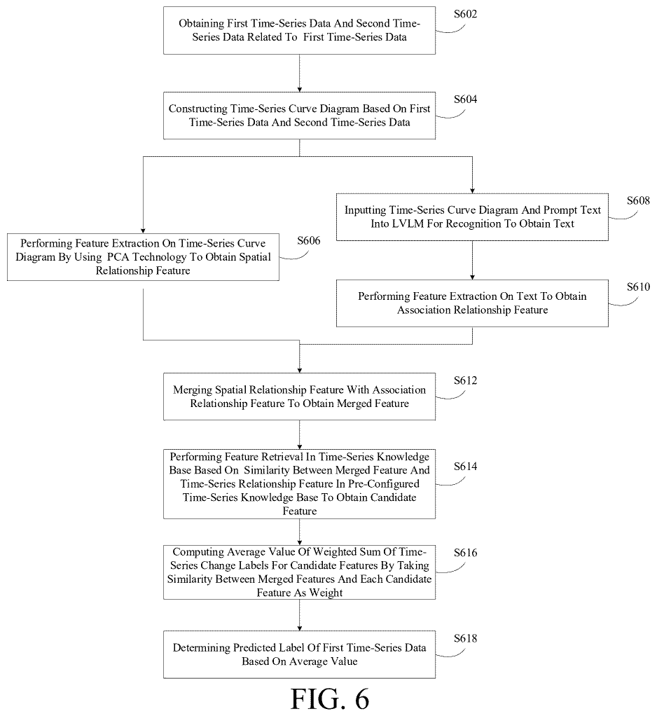

By taking the application of the time-series data processing method according to some embodiments in a time-series trend prediction scenario as an example, the time-series data processing method applicable in the time-series trend prediction scenario according to some embodiments will be described below. Referring to FIG. 5 and FIG. 6, the time-series data processing method applicable in the time-series trend prediction scenario includes Steps S602 to Step S618.

As shown in FIG. 5, a time-series data processing module is configured to perform the spatial feature extraction on the time-series curve diagram, constructed based on the first time-series data and the second time-series data, by using the PCA technology to obtain the spatial relationship feature, configured to perform the association feature extraction on the time-series curve diagram by using the LVLM to obtain the association relationship feature, and configured to merge the spatial relationship feature with the association relationship feature to obtain the merged feature. After obtaining the merged feature output by the time-series data processing module, the feature retrieval is performed in the time-series knowledge base based on the merged feature to obtain the candidate features, and the predicted label of the first time-series data is determined based on the similarities between the merged feature and the candidate features and the time-series change labels respectively for the candidate features.

In the step of constructing the time-series knowledge base, the time-series processing module is configured to perform the spatial feature extraction on the time-series curve diagram constructed based on the first historical time-series data and the second historical time-series data to obtain the historical spatial relationship feature, to perform the association feature extraction on the time-series curve diagram by using the LVLM to obtain the historical association relationship feature, and to merge the historical spatial relationship feature with the historical association relationship feature to obtain the time-series relationship feature. After obtaining the time-series relationship feature output by the time-series data processing module, the time-series data record is generated based on the time-series relationship feature and the time-series change label of the first historical time-series data, and the time-series knowledge base is constructed based on at least one time-series data record.

At Step S602, the first time-series data and the second time-series data related to the first time-series data are obtained.

At Step S604, the time-series curve diagram is constructed based on the first time-series data and the second time-series data.

At Step S606, the feature extraction is performed on the time-series curve diagram by using the PCA technology to obtain the spatial relationship feature.

At Step S608, the time-series curve diagram and the prompt text are input into the LVLM for recognition to obtain the text.

At Step S610, the feature extraction is performed on the text to obtain the association relationship feature.

It should be noted that regarding the sequence of Step S606 and Steps S608 to S610, Step S606 may be performed first and then Steps S608 to S610 may be performed, or Steps S608 to S610 may be performed first and then Steps S606 may be performed. Alternatively, Step S606 and Steps S608 to S610 may be performed concurrently. The sequence of steps S606 and S608 to S610 is not limited thereto.

At Step S612, the spatial relationship feature and the association relationship feature are merged to obtain the merged feature.

At Step S614, the feature retrieval is performed in the time-series knowledge base based on the similarity between the merged features and each time-series relationship feature in the pre-configured time-series knowledge base to obtain the candidate feature.

At Step S616, the average value of the weighted sum of the time-series change labels for the candidate features is computed by taking the similarity between the merged features and each candidate feature as the weight for the corresponding time-series change label.

At Step S618, the predicted label of the first time-series data is determined based on the average value.

It should be noted that any one or a combination of any one or more of Steps S602 to S618 may be combined with any one or a combination of any one or more of Steps S202 to S208 to form an alternative implementation according to the deployment requirements. Further, any one or more technical features in Steps S602 to S618 may be combined with any one or more technical features in Steps S202 to S208 to form an alternative implementation according to the deployment requirements. Alternatively, any one or more of the technical features in Step S602 to Step S618 may be replaced with any one or more of the technical features in Step S202 to Step S208 to form an alternative implementation according to the deployment requirements, and details are not described herein again.

An embodiment of a time-series data processing apparatus is provided below.

In the above-described embodiments, the time-series data processing method is provided, and accordingly, a time-series data processing apparatus is further provided, and will be described below with reference to the accompanying drawings.

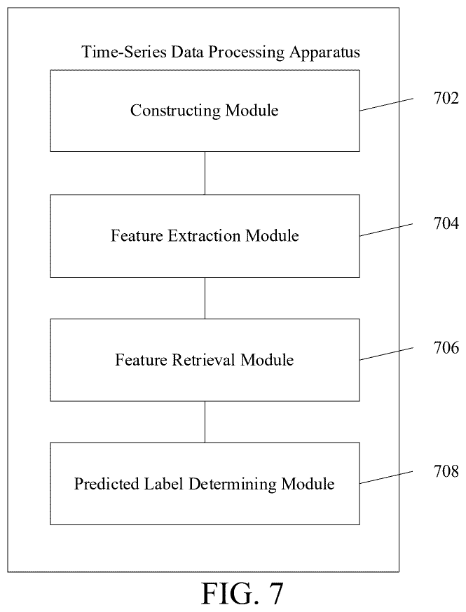

FIG. 7 shows a schematic block diagram of a time-series data processing apparatus according to some embodiments. Since the time-series data processing apparatus according to some embodiments corresponds to the time-series data processing method according to the above embodiments, the description of the time-series data processing apparatus according to some embodiments is relatively brief, and the details may be referred to the corresponding description of the time-series data processing method according to the above embodiments. The time-series data processing apparatus according to some embodiments described below are merely illustrative.

An embodiment provides a time-series data processing apparatus including:
a constructing module 702, configured to construct a time-series curve diagram based on first time-series data and second time-series data;
a feature extraction module 704, configured to perform feature extraction on the time-series curve diagram to obtain a spatial relationship feature, perform association relationship recognition on the time-series curve diagram by using a model to obtain a text, and perform feature extraction on the text to obtain an association relationship feature;
a feature retrieval module 706, configured to merge the spatial relationship feature and the association relationship feature to obtain a merged feature, and perform feature retrieval in a time-series knowledge base based on the merged feature to obtain one or more candidate features; and
a predicted label determining module 708, configured to determine similarities between the merged feature and respective ones of the one or more candidate features, and determine a predicted label of the first time-series data based on the similarities and one or more of time-series change labels for the one or more candidate features.

In an embodiment, the constructing module 702 performs the following steps in the constructing of the time-series curve diagram based on the first time-series data and the second time-series data:
generating a first time-series curve based on the first time-series data and generating a second time-series curve based on the second time-series data, where the first time-series data correspond to a same time period as that correspond to the second time-series data; and
generating the time-series curve diagram based on the first time-series curve and the second time-series curve.

In an embodiment, the feature extraction module 704 performs the following steps in the performing of the feature extraction on the time-series curve diagram to obtain the spatial relationship feature:
performing image sampling on the first time-series curve and the second time-series curve in the time-series curve diagram to obtain first sample data and second sample data, respectively;
merging the first sample data and the second sample data to obtain a merged data matrix, and performing computation on the merged data matrix to obtain a covariance matrix of the merged data matrix; and
performing eigen decomposition on the covariance matrix to obtain the spatial relationship feature.

In an embodiment, the feature extraction module 704 performs the following steps in the performing of the association relationship recognition on the time-series curve diagram by using the model to obtain the text:
inputting the time-series curve diagram and the prompt text into the model for identification to obtain the text, where the prompt text is used to instruct the model to recognize the first and second time-series curves included in the time-series curve diagram and to recognize a time-series change relationship between the first and second time-series curves.

In an embodiment, the feature retrieval module 706 performs the following steps in the performing of the feature retrieval in the time-series knowledge base based on the merged feature to obtain the one or more candidate features:
computing similarities between the merged feature and respective ones of time-series relationship features stored in the time-series knowledge base; and
selecting one or more of the time-series relationship features corresponding to the similarities meeting a preset condition as the one or more candidate features.

In an embodiment, a plurality of time-series data records are stored in the time-series knowledge base, each of the time-series data records includes one of the time-series relationship features and one of the time-series change labels corresponding to the one of the time-series relationship features;
the one or more time-series change labels respectively for the one or more candidate features are read from the time-series data records stored in the time-series knowledge base as the one or more of time-series change labels for the one or more candidate features.

In an embodiment, the predicted label determination module 708 performs the following steps in the determining of the predicted label of the first time-series data based on the similarities and the one or more of the time-series change labels for the one or more candidate features:
computing a weighted sum of the one or more time-series change labels by using the one or more similarities as respective weights for the one or more time-series change labels; and
determining a label value of the predicted label based on the weighted sum.

According to the time-series data processing apparatus according to some embodiments, the time-series curve diagram is first constructed based on the first time-series data and the second time-series data, and then, on one hand, the feature extraction is performed on the time-series curve diagram to obtain the spatial relationship feature; on the other hand, recognition is performed on the time-series curve diagram by using the model to obtain the text, and the feature extraction is performed on the text to obtain the association relationship feature. In this way, the spatial relationship feature and the association relationship feature are extracted from the time-series curve diagram including multivariate time-series data in two dimensions, i.e., a spatial relationship and a relational association. This achieves the representation of the time-series data by relationship features in two dimensions. Further, based on the merged feature obtained by merging the spatial relationship feature with the association relationship feature, feature retrieval is performed in the time-series knowledge base to obtain the candidate feature, the similarity between the merged feature and the candidate feature is determined, and the predicted label of the first time-series data is determined based on the similarity and the time-series change label for the candidate feature, thereby determining the candidate feature by using the pre-configured the time-series knowledge base. The predicted label of the first time-series data is determined based on the similarity between the merged feature and the candidate feature and the time-series change label of the candidate relationship, so that the predicted label may be determined based on the results of the feature extraction and the feature retrieval by using the pre-configured time-series knowledge base, and the efficiency of determining the predicted label of the first time-series data is improved.

A time-series data processing apparatus according to an embodiment is provided.

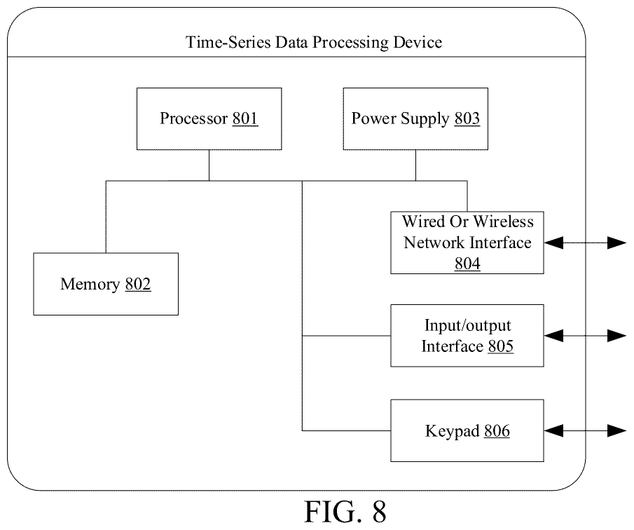

Based on the same technical concept as the time-series data processing method described above, an embodiment of the present disclosure further provides a time-series data processing device configured to perform the time-series data processing method according to some embodiments. FIG. 8 is a schematic block diagram of the time-series data processing device according to an embodiment of the present disclosure.

An embodiment provides a time-series data processing device.

As shown in FIG. 8, the time-series data processing devices may be different due to their different configurations or performance, and may include one or more processors 801 and a memory 802 storing one or more storage applications or data. The memory 802 may be a temporary storage or a persistent storage. The application program stored in memory 802 may include one or more modules (not shown), each of the modules may include a series of computer-executable instructions in a time-series data processing device. Further, the processor 801 may be configured to communicate with the memory 802 to execute the series of computer-executable instructions in the memory 802 by the time-series data processing device. The time-series data processing device may further include one or more power supplies 803, one or more wired or wireless network interfaces 804, one or more input/output interfaces 805, one or more keypads 806, and/or the like.

In an embodiment, the time-series data processing device includes a memory, and one or more programs. One or more programs are stored in the memory, and one or more programs may include one or more modules, and each module may include a series of computer-executable instructions for the time-series data processing device, and configured to be executed by the one or more processors to perform the one or more programs including the computer-executable instructions:
constructing a time-series curve diagram based on first time-series data and second time-series data;
performing feature extraction on the time-series curve diagram to obtain a spatial relationship feature, performing association relationship recognition on the time-series curve diagram by using a model to obtain a text, and performing feature extraction on the text to obtain an association relationship feature;
merging the spatial relationship feature with the association relationship feature to obtain a merged feature, and performing feature retrieval in a time-series knowledge base based on the merged feature to obtain one or more candidate features; and
determining similarities between the merged feature and respective ones of the one or more candidate features, and determining a predicted label of the first time-series data based on the similarities and one or more of time-series change labels for the one or more candidate features.

In an embodiment, the processor, in the constructing of the time-series curve diagram based on the first time-series data and the second time-series data, performs the steps of:
generating a first time-series curve based on the first time-series data and generating a second time-series curve based on the second time-series data, where the first time-series data correspond to a same time period as that correspond to the second time-series data; and
generating the time-series curve diagram based on the first time-series curve and the second time-series curve.

In an embodiment, in the performing of the feature extraction on the time-series curve diagram to obtain the spatial relationship feature, the processor performs the steps of:
performing image sampling on the first time-series curve and the second time-series curve in the time-series curve diagram to obtain first sample data and second sample data, respectively;
merging the first sample data and the second sample data to obtain a merged data matrix, and performing computation on the merged data matrix to obtain a covariance matrix of the merged data matrix; and
performing eigen decomposition on the covariance matrix to obtain the spatial relationship feature.

In an embodiment, in the performing of the association relationship recognition on the time-series curve diagram by using the model to obtain the text, the processor performs the steps of:
inputting the time-series curve diagram and the prompt text into the model for identification to obtain the text, where the prompt text is used to instruct the model to recognize the first and second time-series curves included in the time-series curve diagram and to recognize a time-series change relationship between the first and second time-series curves.

In an embodiment, in the performing of the feature retrieval in the time-series knowledge base based on the merged feature to obtain the one or more candidate features, the processor performs the steps of: for each of the temporal relationship features,
computing a similarity (i.e., first similarity) between the merged feature and the each of the time-series relationship features; and
in response to determining that the first similarity meets a preset condition, taking the each of the temporal relationship features as one of the one or more candidate features.

In an embodiment, a plurality of time-series data records are stored in the time-series knowledge base, each of the time-series data records includes one of the time-series relationship features and one of the time-series change labels corresponding to the one of the time-series relationship features;
the one or more time-series change labels respectively for the one or more candidate features are read from the time-series data records stored in the time-series knowledge base.

In an embodiment, in the determining of the predicted label of the first time-series data based on the similarities and the one or more of the time-series change labels for the one or more candidate features, the processor performs the steps of:
computing a weighted sum of the one or more time-series change labels by using the one or more similarities as respective weights for the one or more time-series change labels; and
determining a label value of the predicted label based on the weighted sum.

According to the time-series data processing device according to some embodiments, the time-series curve diagram is first constructed based on the first time-series data and the second time-series data, and then, on one hand, the feature extraction is performed on the time-series curve diagram to obtain the spatial relationship feature; on the other hand, recognition is performed on the time-series curve diagram by using the model to obtain the text, and the feature extraction is performed on the text to obtain the association relationship feature. In this way, the spatial relationship feature and the association relationship feature are extracted from the time-series curve diagram including multivariate time-series data in two dimensions, i.e., a spatial relationship and a relational association. This achieves the representation of the time-series data by relationship features in two dimensions. Further, based on the merged feature obtained by merging the spatial relationship feature with the association relationship feature, feature retrieval is performed in the time-series knowledge base to obtain the candidate feature, the similarity between the merged feature and the candidate feature is determined, and the predicted label of the first time-series data is determined based on the similarity and the time-series change label for the candidate feature, thereby determining the candidate feature by using the pre-configured the time-series knowledge base. The predicted label of the first time-series data is determined based on the similarity between the merged feature and the candidate feature and the time-series change label of the candidate relationship, so that the predicted label may be determined based on the results of the feature extraction and the feature retrieval by using the pre-configured time-series knowledge base, and the efficiency of determining the predicted label of the first time-series data is improved.

A computer-readable storage medium according to some embodiments is provided.

Based on the same technical concept as the time-series data processing method described above, an embodiment of the present disclosure further provides a computer-readable storage medium.

A computer-readable storage medium according to an embodiment is configured to store computer-executable instructions that, when executed, perform the following operations:
constructing a time-series curve diagram based on first time-series data and second time-series data;
performing feature extraction on the time-series curve diagram to obtain a spatial relationship feature, performing association relationship recognition on the time-series curve diagram by using a model to obtain a text, and performing feature extraction on the text to obtain an association relationship feature;
merging the spatial relationship feature with the association relationship feature to obtain a merged feature, and performing feature retrieval in a time-series knowledge base based on the merged feature to obtain one or more candidate features;
determining similarities between the merged feature and respective ones of the one or more candidate features, and determining a predicted label of the first time-series data based on the similarities and one or more of time-series change labels in the preset time-series knowledge base for the one or more candidate features.

It should be noted that the computer-readable storage medium according to some embodiments has the same inventive concept as the time-series data processing method described above. Therefore, the description of the computer-readable storage medium according to some embodiments may be referred to the time-series data processing method described above, and details are not repeated.

An embodiment of the present disclosure provides a computer program product that includes a computer program that, when executed by a processor, performs the following operations:
constructing a time-series curve diagram based on first time-series data and second time-series data;
performing feature extraction on the time-series curve diagram to obtain a spatial relationship feature, performing association relationship recognition on the time-series curve diagram by using a model to obtain a text, and performing feature extraction on the text to obtain an association relationship feature;
merging the spatial relationship feature with the association relationship feature to obtain a merged feature, and performing feature retrieval in a time-series knowledge base based on the merged feature to obtain one or more candidate features; and
determining similarities between the merged feature and respective ones of the one or more candidate features, and determining a predicted label of the first time-series data based on the similarities and one or more of time-series change labels for the one or more candidate features.

According to the computer program product according to some embodiments, the time-series curve diagram is first constructed based on the first time-series data and the second time-series data, and then, on one hand, the feature extraction is performed on the time-series curve diagram to obtain the spatial relationship feature; on the other hand, recognition is performed on the time-series curve diagram by using the model to obtain the text, and the feature extraction is performed on the text to obtain the association relationship feature. In this way, the spatial relationship feature and the association relationship feature are extracted from the time-series curve diagram including multivariate time-series data in two dimensions, i.e., a spatial relationship and a relational association. This achieves the representation of the time-series data by relationship features in two dimensions. Further, based on the merged feature obtained by merging the spatial relationship feature with the association relationship feature, feature retrieval is performed in the time-series knowledge base to obtain the candidate feature, the similarity between the merged feature and the candidate feature is determined, and the predicted label of the first time-series data is determined based on the similarity and the time-series change label for the candidate feature, thereby determining the candidate feature by using the pre-configured the time-series knowledge base. The predicted label of the first time-series data is determined based on the similarity between the merged feature and the candidate feature and the time-series change label of the candidate relationship, so that the predicted label may be determined based on the results of the feature extraction and the feature retrieval by using the pre-configured time-series knowledge base, and the efficiency of determining the predicted label of the first time-series data is improved.

The computer program product according to some embodiments of the present disclosure may perform the operations of the time-series data processing method according to some embodiments and achieve the same effects and functions as the time-series data processing method, and will not be repeated here.

In some cases, the operations recited in the claims may be performed in an order different from that described in the embodiments and still achieve the desired results. Furthermore, the processes depicted in the accompanying drawings do not necessarily require the specific or the sequential order shown to achieve the desired results. In certain implementations, multitasking and parallel processing may be possible or may be advantageous.

Those skilled in the art will appreciate that embodiments of the present disclosure may be provided as a method, system, or computer program product. Thus, the present disclosure may take the form of a full hardware embodiment, a full software embodiment, or an embodiment incorporating both software and hardware aspects. Furthermore, the present disclosure may take the form of a computer program product embodied on one or more computer usable storage media (including, but not limited to, magnetic disk memory, CD-ROM, optical memory, etc.) having computer usable program code embodied therein.

The present disclosure is described with reference to flowcharts and/or block diagrams of methods, devices (systems), and computer program products according to embodiments of the present disclosure. It is to be understood that each operation and/or block in the flowcharts and/or block diagrams, and combinations of the operations and/or blocks in the flowcharts and/or block diagrams may be implemented by computer program instructions. These computer program instructions may be provided to a processor of a general purpose computer, a special purpose computer, an embedded processor, or other programmable testing device to generate a machine such that the instructions executable by the processor of the computer or other programmable testing device generate means for performing operations specified in one or more flows in the flowchart and/or one or more blocks in the block diagram.

These computer program instructions may further be stored in a computer-readable memory configured to direct a computer or other programmable testing apparatus to operate in a particular manner, such that the instructions stored in the computer-readable memory generate an manufacture product including instruction means that perform operations specified in one or more flows in the flowchart and/or one or more blocks in the block diagram.

These computer program instructions may further be loaded onto a computer or other programmable testing device such that a series of operational steps are performed on the computer or the other programmable device to generate a computer-implemented process, such that the instructions that execute on the computer or the other programmable device provide steps for performing operations specified in one or more flows in the flowchart and/or one or more blocks in the block diagram.

In an example configuration, the computing device includes one or more processors (for example, central processing units (CPUs)), input/output interfaces, network interfaces, and a memory.

The memory may include non-permanent memory, random access memory (RAM), and/or non-volatile memory such as read only memory (ROM) or flash memory (flash RAM) in the computer-readable medium. The memory is an example of a computer-readable medium.

The computer-readable media, including permanent and non-permanent, removable and non-removable media, may store information by any method or technique. The information may be computer-readable instructions, data structures, program modules, or other data. Examples of storage media of a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassette tape, magnetic disk storage or other magnetic storage device, or any other non-transmission medium that may be used to store information that accessible by a computing device. As defined herein, the computer-readable medium does not include a transitory media, such as a modulated data signal and a carrier wave.

It is also noted that the terms “including” “comprising” or any other variation thereof, are intended to cover a non-exclusive inclusion, such that a process, a method, an article, or a device that includes a list of elements includes not only those elements but also other elements not expressly listed, or further includes elements inherent to such process, method, article, or device. In the absence of further limitations, elements defined by the statement “include . . . ” do not exclude the presence of additional same elements in the process, method, article, or device that includes the elements.

Some embodiments of the present disclosure may be described in the general context, such as a program module, of computer-executable instructions executable by a computer. Generally, the program module includes routines, programs, objects, components, data structures, etc. that perform particular tasks or implement particular abstract data types. Or the embodiments of the present disclosure may be practiced in a distributed computing environment in which tasks are performed by remote processing devices connected through a communication network. In the distributed computing environment, the program module may be located in local and remote computer storage media, including storage devices.

The various embodiments in the present disclosure are described in a progressive manner. Similar or identical parts across embodiments may be understood through mutual reference. Each embodiment focuses on its differences from the other embodiments. In particular, the system embodiments are generally similar to the method embodiments, so they are described more briefly. For relevant details, please refer to the descriptions of the method embodiments.

Some embodiments of the present disclosure have been described in detail above. The description of the above embodiments merely aims to facilitate understanding of the present disclosure. Many modifications or equivalent substitutions with respect to the embodiments may occur to those of ordinary skill in the art. Thus, these modifications or equivalent substitutions shall fall within the scope of the present disclosure.

What is claimed is:

1. A time-series data processing method, comprising:
constructing a time-series curve diagram based on first time-series data and second time-series data;
performing feature extraction on the time-series curve diagram to obtain a spatial relationship feature, performing association relationship recognition on the time-series curve diagram by using a neural network model to obtain a text, and performing feature extraction on the text to obtain an association relationship feature;
merging the spatial relationship feature with the association relationship feature to obtain a merged feature, and performing feature retrieval in a time-series knowledge base based on the merged feature to obtain one or more candidate features; and
determining one or more similarities respectively for the one or more candidate features, wherein each of the one or more similarities is a similarity between the merged feature and one of the one or more candidate features, and determining a predicted label for the first time-series data based on the one or more similarities and one or more time-series change labels respectively for the one or more candidate features.

2. The time-series data processing method of claim 1, wherein the constructing of the time-series curve diagram based on the first time-series data and the second time-series data comprises:
generating a first time-series curve based on the first time-series data and generating a second time-series curve based on the second time-series data, wherein the first time-series data corresponds to a same time period as the second time-series data; and
generating the time-series curve diagram based on the first time-series curve and the second time-series curve.

3. The time-series data processing method of claim 1, wherein the performing of the feature extraction on the time-series curve diagram to obtain the spatial relationship feature comprises:
performing image sampling on a first time-series curve and a second time-series curve in the time-series curve diagram to obtain first sample data and second sample data, respectively;
merging the first sample data with the second sample data to obtain a merged data matrix, and computing a covariance matrix of the merged data matrix; and
performing eigen decomposition on the covariance matrix to obtain the spatial relationship feature.

4. The time-series data processing method of claim 1, wherein the performing of the association relationship recognition on the time-series curve diagram by using the neural network model comprises:
performing the association relationship recognition by inputting, into the neural network model, the time-series curve diagram and a prompt text for instructing the neural network model to recognize respective time-series curves in the time-series curve diagram and recognize a time-series change relationship between the respective time-series curves.

5. The time-series data processing method of claim 1, wherein a plurality of temporal relationship features are stored in the time-series knowledge base; and
the performing of the feature retrieval in the time-series knowledge base based on the merged feature to obtain the one or more candidate features comprises: for each of the temporal relationship features,
computing a first similarity between the merged feature and the each of the time-series relationship features; and
in response to determining that the first similarity meets a preset condition, taking the each of the temporal relationship features as one of the one or more candidate features.

6. The time-series data processing method of claim 1, wherein a plurality of time-series data records are stored in the time-series knowledge base, each of the time-series data records comprising one of a plurality of time-series relationship features and one of a plurality of time-series change labels corresponding to the one of the plurality of time-series relationship features; and
the one or more time-series change labels respectively for the one or more candidate features are read from the time-series data records stored in the time-series knowledge base.

7. The time-series data processing method of claim 1, wherein the determining of the predicted label for the first time-series data based on the one or more similarities and the one or more time-series change labels comprises:
computing a weighted sum of the one or more time-series change labels by using the one or more similarities as respective weights for the one or more time-series change labels; and
determining a label value of the predicted label based on the weighted sum.

8. A time-series data processing device, comprising: a processor; and a memory storing instructions executable by the processor to perform operations comprising:
constructing a time-series curve diagram based on first time-series data and second time-series data;
performing feature extraction on the time-series curve diagram to obtain a spatial relationship feature, performing association relationship recognition on the time-series curve diagram by using a neural network model to obtain a text, and performing feature extraction on the text to obtain an association relationship feature;
merging the spatial relationship feature with the association relationship feature to obtain a merged feature, and performing feature retrieval in a time-series knowledge base based on the merged feature to obtain one or more candidate features; and
determining one or more similarities respectively for the one or more candidate features, wherein each of the one or more similarities is a similarity between the merged feature and one of the one or more candidate features, and determining a predicted label for the first time-series data based on the one or more similarities and one or more time-series change labels respectively for the one or more candidate features.

9. The time-series data processing device of claim 8, wherein the constructing of the time-series curve diagram based on the first time-series data and the second time-series data comprises:
generating a first time-series curve based on the first time-series data and generating a second time-series curve based on the second time-series data, wherein the first time-series data corresponds to a same time period as the second time-series data; and
generating the time-series curve diagram based on the first time-series curve and the second time-series curve.

10. The time-series data processing device of claim 8, wherein the performing of the feature extraction on the time-series curve diagram to obtain the spatial relationship feature comprises:
performing image sampling on a first time-series curve and a second time-series curve in the time-series curve diagram to obtain first sample data and second sample data, respectively;
merging the first sample data with the second sample data to obtain a merged data matrix, and computing a covariance matrix of the merged data matrix; and
performing eigen decomposition on the covariance matrix to obtain the spatial relationship feature.

11. The time-series data processing device of claim 8, wherein the performing of the association relationship recognition on the time-series curve diagram by using the neural network model comprises:
performing the association relationship recognition by inputting, into the neural network model, the time-series curve diagram and a prompt text for instructing the neural network model to recognize respective time-series curves in the time-series curve diagram and recognize a time-series change relationship between the respective time-series curves.

12. The time-series data processing device of claim 8, wherein a plurality of temporal relationship features are stored in the time-series knowledge base; and
the performing of the feature retrieval in the time-series knowledge base based on the merged feature to obtain the one or more candidate features comprises: for each of the temporal relationship features,
computing a first similarity between the merged feature and the each of the time-series relationship features; and
in response to determining that the first similarity meets a preset condition, taking the each of the temporal relationship features as one of the one or more candidate features.

13. The time-series data processing device of claim 8, wherein a plurality of time-series data records are stored in the time-series knowledge base, each of the time-series data records comprising one of a plurality of time-series relationship features and one of a plurality of time-series change labels corresponding to the one of the plurality of time-series relationship features; and
the one or more time-series change labels respectively for the one or more candidate features are read from the time-series data records stored in the time-series knowledge base.

14. The time-series data processing device of claim 8, wherein the determining of the predicted label for the first time-series data based on the one or more similarities and the one or more time-series change labels comprises:
computing a weighted sum of the one or more time-series change labels by using the one or more similarities as respective weights for the one or more time-series change labels; and
determining a label value of the predicted label based on the weighted sum.

15. A non-transitory computer-readable storage medium storing instructions executable by a processor to perform the time-series data processing method of claim 1.

16. A computer program product comprising a computer program executable by a processor to perform the time-series data processing method of claim 1.
